(19) United States
(12) Patent Application Publication
(10) Pub. No.: US 2026/0344646 A1
(43) Pub. Date: Nov. 5, 2026

(54) METHOD, A SYSTEM AND AN APPLICATOR FOR PREVENTING OR MITIGATING ELECTRIC ARCS, AND COMPUTER READABLE STORAGE MEDIUM

(71) Applicants: Zasso Group AG, Zug (CH); Zasso Brasil Indústria e Comércio de Máquinas Ltda., Indaiatuba, São Paulo (BR)

(72) Inventors: Sergio de Andrade COUTINHO FILHO, Indaiatuba, São Paulo (BR); Christopher FREIMANN, Eschweiler (DE)

(73) Assignees: Zasso Group AG, Zug (CH); Zasso Brasil Indústria e Comércio de Máquinas Ltda., Indaiatuba, São Paulo (BR)

(21) Appl. No.: 19/111,810

(22) PCT Filed: Sep. 14, 2022
(86) PCT No.: PCT/BR2022/050365

§ 371 Date: Mar. 14, 2025

(51) Int. Cl. A01M 21/04

(52) U.S. Cl. CPC A01M 21/046

(57) ABSTRACT

The present invention relates to a method and a system for preventing or mitigating electric arcs in electrical weeding applicators comprising electrodes (1a,1b) near the soil and one power supply coupled to the electrodes (1a, 1b). The invention comprises a monitoring module coupled to the electrodes (1a, 1b) and configured to sense an electrical parameter (7); and a control module coupled to the power supply and the monitoring module, wherein the control module is configured to: switch OFF (15) power supply to the electrodes (1a, 1b) if the sensed electrical parameter has a value (13) indicative that a region of higher conductivity (3) has connected two electrodes; and after a determined time interval (18), switch ON (14) the power supply.

The invention also relates to a computer readable storage medium comprising stored therein in instructions which, when executed by one or more processors, cause the processor to perform the method as defined in the present invention.

Lastly, the invention relates to an electrical weeding applicator comprising the system according to the present invention and capable of performing the method according to the invention.

### FIELD OF THE DISCLOSURE

The present invention relates to the field of electrical weeding systems, devices, and processes. More specifically, the invention relates to a system and method for preventing, or at least reducing, the formation of electric arcs in an electrical weeding system/device/vehicle by detecting regions in or near the soil with higher electrical conductivity (e.g., metallic objects).

### DESCRIPTION OF RELATED ART

The prevention of electric arcs in existing apparatuses or devices for killing/neutralizing undesired plants (e.g., weeds) in agricultural scenarios, although very relevant, is not very discussed in the art. In spite of the existing solutions, there are considerable limitations in their approaches to this problem. These limitations will become apparent after the comments below.

Document WO 2021/053,086 A1, titled “METHOD AND DEVICE FOR MINIMIZING THE RISK OF FIRE AND USE OF A DEVICE SUITABLE THEREFOR” teaches a device for minimizing the risk of fire in weed control applications using high voltage by reducing the formation of electric arcs. WO 2021/053,086 A1 states that arcs are detected by analyzing characteristic partial discharge or current and voltage values, which are prevented by: use of round, channel-less geometries; use of depth electrodes; and/or the use of high ground contact pressures (see Abstract of WO 2021/053,086 A1). WO 2021/053,086 A1 teaches ways to detect the formation of electric arcs, such as: by means of a capacitive sensor, which may serve as an antenna (see paragraph 5 of WO 2021/053,086 A1) and by monitoring the output values of energy sources (see at least paragraph 12 of WO 2021/053,086 A1).

Document WO 2020/182,818 A1, titled “APPARATUS AND METHOD FOR ELECTRICALLY KILLING PLANTS” teaches an electrical apparatus to kill a plant or at least attenuate plant growth which comprises: a power supply unit; an applicator unit comprising an applicator electrode; a return unit comprising a return electrode; electrical circuitry; the power supply unit arranged to apply electrical energy through a transmission circuit comprising the applicator electrode, and the return electrode, wherein said electrical circuitry implements a detection system to determine a condition of electrical arcing of the electrical energy from one or both of said electrodes, the electrical circuitry arranged to control the electrical energy through the transmission circuit to at least partially reduce the electrical arcing based on said determined condition of electrical arcing.

The detection system disclosed in document WO 2020/182,818 A1 includes several different detection systems and arrangements thereof, including: detection system based on determining electrical noise; a detection system based on determining a change in property of the electrical energy; a detection system implementing a camera. These detection systems are based on one or more sensors, such as: cameras for different wavebands, thermal sensors, circuitry for detecting emission of electrical noise and circuitry for determining changes in properties of the electrical energy.

Even though WO 2021/053,086 A1 teaches electrodes that touch the soil and several techniques and sensors to monitor conditions of the electrodes, WO 2021/053,086 A1 is not capable of detecting or mitigating any electrical discharges (or electric arcs) that may arise after separation of one electrode and a more conductive region (e.g., when loosing contact with a metallic object).

Document WO 2020/182,818 A1 suffers from the same limitation. Although extensively teaching different sensors, they only address scenarios in which the arcs are happening between the electrode and the plant or between electrodes, having the air as a medium.

As such, none of the documents in the art seem to address a situation in which a foreign objected is the cause of the electric arcing. Furthermore, none of the documents are concerned with preventing or mitigating arcs between the electrode and foreign objects (unrelated to the weeds or plants being treated).

### OBJECTIVES OF THE INVENTION

It is therefore an objective of the present invention to provide a method for detecting and preventing, or at least mitigating, electric arcing between the electrodes of electrical weeding devices/vehicles and foreign objects (e.g., wet or highly humid soil and metallic objects).

It is another objective of the present invention to teach a system capable of preventing, or at least mitigating, electric arcing between the electrodes of electrical weeding devices/vehicles and foreign objects.

A further objective of the present invention is providing a method and system for mapping regions of interest when a foreign object capable of generating an electric arc with the electrodes is detected.

### SUMMARY OF THE INVENTION

As such, the present invention more particularly relates to a method for preventing electric arcs in an electrical weeding applicator. The applicator comprising at least one pair of electrodes 1a,1b near or in contact with the soil and at least one power supply electrically coupled to the at least one pair of electrodes 1a, 1b. The method comprising the steps of:
sensing at least one electrical parameter between the at least one pair of electrodes;
switching OFF power supply to the at least one pair of electrodes if the sensed electrical parameter has a value indicative that a region of higher conductivity has connected at least two electrodes of the at least one pair of electrodes;
after a determined time interval, switching ON the power supply.

In addition to the method above, the present invention also includes an electrical weeding system for preventing electric arcs in electrical weeding applicators. The applicator, which can be a vehicle, handheld or hand-pushed device, comprises at least one pair of electrodes 1a, 1b near or in contact with the soil and at least one power supply electrically coupled to the at least one pair of electrodes 1a, 1b, the system comprising:
a monitoring module coupled to the at least one pair of electrodes and configured to sense at least one electrical parameter; and
a control module coupled to the at least one power supply and the monitoring module, wherein the control module is configured to:
   switch OFF power supply to the at least one pair of electrodes if the sensed electrical parameter has a value indicative that a region of higher conductivity has connected at least two electrodes of the at least one pair of electrodes; and
   after a determined time interval, switch ON the power supply.

Furthermore, the present invention also relates to computer readable storage mediums which comprise instructions to encompass one or more processors to perform the any of the steps associated with the method according to the present invention.

Lastly, the present invention also relates to an electric weeding applicator, which can be a vehicle, handheld or hand-pushed device, capable of preventing or mitigating electric arcs comprising:
at least one pair of electrodes 1a, 1b near or in contact with the soil;
at least one power supply electrically coupled to the at least one pair of electrodes 1a, 1b;
the system comprising:
a monitoring module coupled to the at least one pair of electrodes 1a, 1b and configured to sense at least one electrical parameter 7; and
a control module coupled to the at least one power supply and the monitoring module, wherein the control module is configured to:
   switch OFF 15 power supply to the at least one pair of electrodes 1a, 1b if the sensed electrical parameter has a value 13 indicative that a region of higher conductivity 3 has connected at least two electrodes of the at least one pair of electrodes 1a, 1b; and
   after a determined time interval 18, switch ON 14 the power supply.

### BRIEF DESCRIPTION OF THE DRAWINGS

The invention is explained in greater detail below and makes references to the drawings and figures, attached herewith, when necessary.

[symbol] shows an example of an electrical weeding vehicle.

[symbol] shows an operator with a first example of a portable handheld electrical weeding device.

[symbol] shows a second example of a portable hand-pushed electrical weeding device.

[symbol] depicts a scenario in which a spark is formed during movement of an electrical weeding vehicle/device.

[symbol] shows an illustrative plot in time of output voltages for the scenario of [symbol] and a switching signal according to an embodiment of the present invention.

[symbol] shows an illustrative arrangement of a pair of electrodes according to an example embodiment of the present invention.

### DETAILED DESCRIPTION OF THE INVENTION

As mentioned previously, the present invention relates to a system and method for preventing, or at least reducing, the formation of electric arcs by detecting regions in the soil with higher electrical conductivity (e.g., metallic objects).

It is easily appreciated by those skilled in the art that, although the present disclosure makes reference to specific technologies and components, several other technologies and components capable of performing the same or equivalent functions may replace those disclosed herein while still being part of the scope of the present invention.

In the context of the present disclosure, the electrical weeding devices and vehicles are generally and more broadly referred to as “electrical weeding applicators”, or simply “applicator”, unless where otherwise specified.

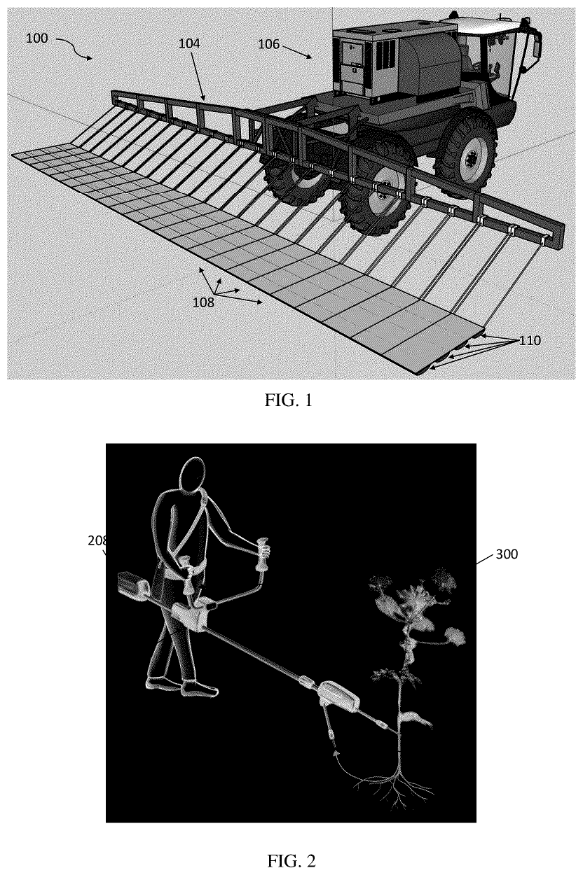

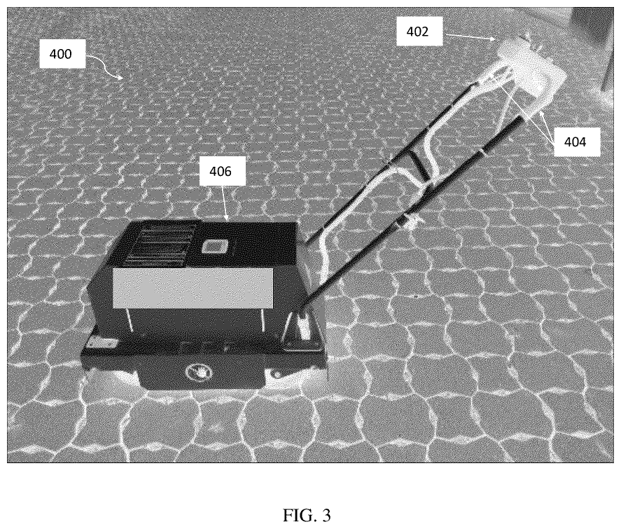

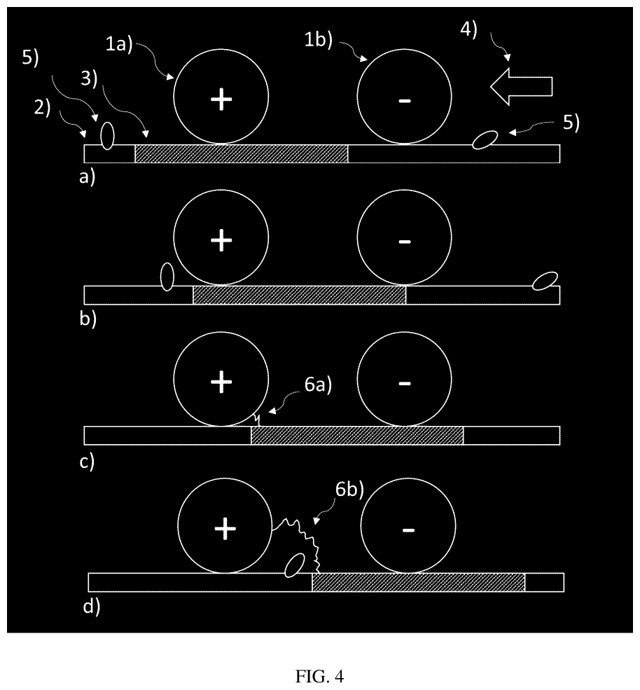

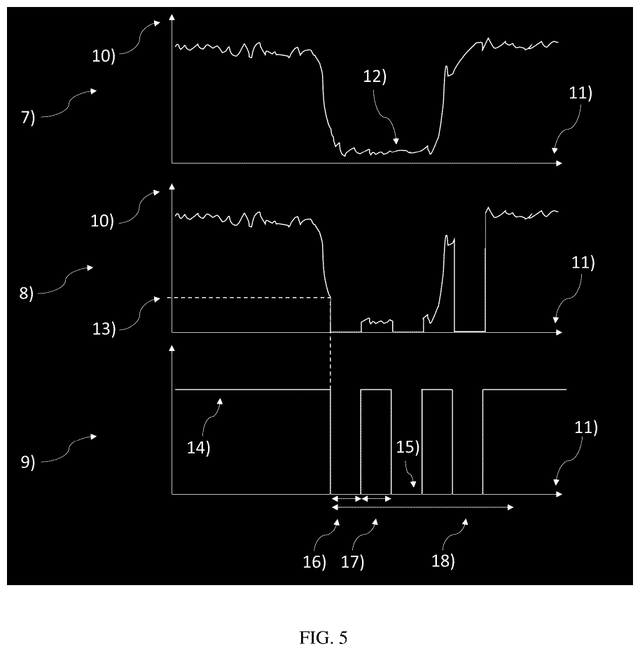

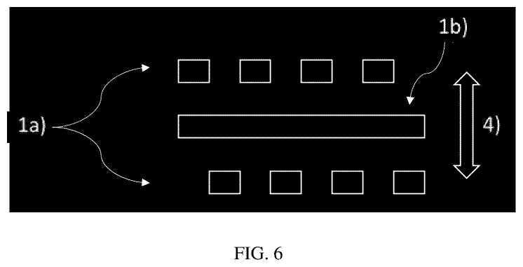

FIGS. 1, 2 and 3 show exemplary embodiments of electrical applicators that may make use of the method and system according to the present invention. The general electrical weeding device comprises an electrical power source, a plurality of electrodes and a control unit.

In particular, [symbol] shows a vehicle 100 comprising a horizontal beam 104 attached thereto supporting a plurality of mounts 108 each coupled to a plurality of electrodes 110. In addition, the vehicle 100 comprises a housing 106 which holds a power source, and a general control unit.

[symbol] shows a portable handheld electrical weeding device 200. This handheld device comprises two handles coupled to a housing of the control unit 204. The control unit 204 is coupled to a main shaft 206 which extends both upstream and downstream of the control unit 204. Upstream of the control unit is the power source 208 coupled to an end of the main shaft 206. Downstream of the control unit 206 is the electronic converter 208 coupled to the other end of the main shaft 204. Coupled to the electronic converter is the plurality of electrodes 210 which will deliver the current to kill the plant 300. A usual path of the current is shown by the arrow connecting the electrodes 210.

[symbol] shows yet another portable electrical weeding device 400. This device 400 comprises a panel 402 attached to two handles 404. The handles extend downwardly to connect to a housing 406, the housing 406 comprising a power source and a general control unit.

[symbol] illustrates a common scenario in which electric sparks may form during operation of an electrical weeding system/device as the ones shown in FIG. 1, 2 or 3. In this scenario, a pair of electrodes 1a, 1b with different electrical charges are shown, which move relative to the substrate 2 in a direction of travel 4 signaled by the arrow and which is maintained throughout this scenario. A high voltage is being applied between the pair of electrodes 1a, 1b to treat unwanted weeds 5 by means of generating a current flow between the pair of electrodes 1a,1b through the soil. A region of higher electrical conductivity 3 (e.g., a metallic object) is located on the substrate 2.

In stage (a) the region of higher electrical conductivity 3 comes into contact with a first electrode 1a of the pair of electrodes 1a, 1b. At that moment, the area of higher electrical conductivity 3 becomes charged with the same charge of the first electrode 1a.

In stage (b), both electrodes of the pair of electrodes 1a, 1b have now come in contact with the region of higher electrical conductivity 3. The pair of electrodes 1a, 1b are then connected (or “bridged”) by the region of higher electrical conductivity 3, which in turn reduces the voltage between the electrodes of the pair of electrodes 1a, 1b. This reduction is given as a function of the conductivity of the region of higher electrical conductivity 3; the contact resistances between each electrode of the pair of electrodes 1a, 1b and the region of increased electrical conductivity 3; and the electrical power supplied to the pair of electrodes 1a, 1b. Even if the electrodes of the pair of electrodes 1a, 1b are not short-circuited (i.e., the voltage between them is OV) due to the region of higher electrical conductivity 3, the voltage reduction may be substantial, nonetheless. In this stage (b), an increased output current between the electrodes of the pair of electrodes 1a, 1b may occur.

In stage (c), as the pair of electrodes keeps moving in the direction of travel 4, the first electrode la of the pair of electrodes 1a, 1b loses contact with the region of higher electrical conductivity 3. Since the pair of electrodes 1a, 1b is no longer connected by the region of higher conductivity 3, the high voltage difference will return. As a result, ionization processes start in the air and, if the breakdown voltage of the medium (which varies with temperature, moisture, air pressure, etc.) is reached, an electric spark 6a may be created between the electrode and the region of higher electrical conductivity 3.

After forming, electric arcs will be maintained unless the power supply is shutdown (even if momentarily) or external factors act on the arc. The movement of the pair of electrodes 1a,1b in the direction of travel 4 causes the distance between the first electrode la and the region of higher electrical conductivity 3 to increase, which may increase the size of the electric arc 6a and lead to the formation of a plasma channel 6b. The high temperature of the electric arc 6a and the plasma channel 6b may cause physical damage to the system, reduced biological effectiveness of the treatment or other safety-relevant effects (e.g., fire or shocking nearby individuals). The aim is therefore to reduce arcing.

The present invention proposes, therefore, a method and system for controlling power supply to one or more electrodes by monitoring output values of the electrical weeding device/system that indicate that an electric arc may form or has already formed between the electrode and a region of higher conductivity near the soil. By controlling the amount of power supplied to the one or more electrodes, the electric arc may be extinguished for lack of energy to sustain itself. A very positive by-product of the method and system according to the present invention is that they may be used to detect metal.

[symbol] illustrates voltage outputs during the example scenario in [symbol] . shows an output voltage 7, which is measured in the pair of electrodes 1a, 1b shown in [symbol] , a corrected output voltage 8, and a switching signal 9, the switching signal 9 having an “ON” state 14 and an “OFF” state 15. The vertical axis 10 is voltage, and the horizontal axis 11 is time. The corrected output voltage 8 is a combination of the output voltage 7 and the switching signal 9.

In the output voltage plot 7, the voltage between the electrodes of the pair of electrodes 1a, 1b starts on a higher level (stage (a) shown in [symbol] and decreases to a lower voltage level 12 when the electrodes come in contact with the region of higher conductivity 3 (stage (b) shown in [symbol] ). By switching OFF the output voltage at a limit value (or threshold) 13, the electrical power supply to the electric arc is interrupted. Preferably, the circuit has an OFF time 16 and an ON time 17 cycle which repeats periodically, regardless of the output voltage, until a time interval 18 has elapsed. The OFF time 16 and the ON time 17 are less than or equal to the time interval 18. If the time interval 18 has elapsed and the output voltage is above the limit value 13, it is an indication that the region of increased conductivity 3 (e.g., a metal object) has passed. If the output voltage is still below the limit value 13, the OFF time 16 and ON time 17 cycle starts again for the duration of the time interval 18. In an alternative embodiment of this circuit, the OFF time 16 is equal to the time interval 18 and the ON time 17 is therefore 0 ms.

As such, the present invention more particularly relates to a method for preventing electric arcs in an electrical weeding applicator. The applicator comprising at least one pair of electrodes 1a,1b near or in contact with the soil and at least one power supply electrically coupled to the at least one pair of electrodes 1a, 1b. The method comprising the steps of:
sensing at least one electrical parameter 7 between the at least one pair of electrodes 1a, 1b;
switching OFF 15 power supply to the at least one pair of electrodes 1a, 1b if the sensed electrical parameter has a value 13 indicative that a region of higher conductivity 3 has connected at least two electrodes of the at least one pair of electrodes 1a, 1b;
after a determined time interval 18, switching ON 14 the power supply.

In preferred embodiments, the at least one electrical parameter is selected from the group comprising a voltage, a current, an impedance and an electrical power.

Preferably, the method of the present invention further comprises the steps of:
before the determined time interval 18 has elapsed, momentarily switching ON 14 the power supply and sensing the at least one electrical parameter 7; and
keeping the power supply switched ON 14 if the at least one sensed electrical parameter 7 has a value 13 indicative that the at least one pair of electrodes 1a, 1b is not connected by a region of higher electrical conductivity 3.

In addition to the method above, the present invention also includes an electrical weeding system for preventing electric arcs in electrical weeding applicators. The applicator, which can be a vehicle, handheld or hand-pushed device, comprises at least one pair of electrodes 1a, 1b near or in contact with the soil and at least one power supply electrically coupled to the at least one pair of electrodes 1a, 1b, the system comprising:
a monitoring module coupled to the at least one pair of electrodes 1a, 1b and configured to sense at least one electrical parameter 7; and
a control module coupled to the at least one power supply and the monitoring module, wherein the control module is configured to:
   switch OFF 15 power supply to the at least one pair of electrodes 1a, 1b if the sensed electrical parameter has a value 13 indicative that a region of higher conductivity 3 has connected at least two electrodes of the at least one pair of electrodes 1a, 1b; and
   after a determined time interval 18, switch ON 14 the power supply.

The monitoring module may, for example, comprise one or more sensors capable of sensing and measuring electrical parameters, such as current, voltage, power or impedance. These sensors may comprise electrical, magnetic, or optical sensors.

The control module may, for example, may comprise one or more processors and a storage medium. The storage medium comprising instructions to allow the processor to process the information provided by the sensors in the monitoring module and compare it with the limit value 13 to make a decision.

Analogous to the method, the at least one electrical parameter sensed by the monitoring module is selected from the group comprising a voltage, a current, an impedance and an electrical power.

In one preferred embodiment, the control module is further configured to:
before the determined time interval 18 has elapsed, momentarily switch ON 14 the power supply and checking the sensed at least one electrical parameter 7; and
keep the power supply switched ON 14 if the at least one sensed electrical parameter 7 has a value 13 indicative that the at least one pair of electrodes 1a, 1b is not connected by a region of higher electrical conductivity 3.

As mentioned previously, the system according to the present invention can be installed in one of a vehicle, a handheld device or a hand-pushed device.

In another embodiment, the time interval 18, i.e., the periodic repetition of OFF time 16 and ON time 17, is interrupted immediately or with a small delay (in ms) as soon as it is detected that the output value 7 is equal or greater than the limit value 13.

In yet another embodiment, the switching signal 9 can also be used to control an H-bridge. In this case, the forwarding of a pulsed signal to the H-bridge is allowed in the ON state 14 and suppressed in the OFF state 15. While the pulsed signal is typically in the kHz range, the switching signal 9 is typically in the Hz range.

The system according to the present invention may also include a position module and a mapping module. These modules may comprise storage mediums, one or more processors and a GPS module. They are configured to, in combination, store the locations where the output voltage 7 was, for example, below the limit value 13. This allows mapping an area to highlight regions of interest (e.g., regions with higher electrical conductivity). By means of a signaling module comprising means to send, receive and/or display alerts to a user, a driver may access a database or be notified while driving (e.g., by means of a display on a vehicle dashboard) when approaching a region of higher conductivity (e.g., metal object) that has been previously located by the system and method according to the present invention. The driver can react based on the provided information and further reduce the likelihood of electric arcing taking place.

Therefore, in a further preferred embodiment, the method comprises the steps of:
determining and storing locations where the sensed electrical parameter 7 indicated that a region of higher electrical conductivity 3 connected at least two electrodes of the at least one pair of electrodes 1a, 1b;
placing said locations on a map; and
alerting a user when approaching said locations.

Similarly, in a preferred embodiment, the system comprises:
a positioning module configured to determine and store locations where the sensed electrical parameter 7 indicated that a region of higher electrical conductivity 3 connected at least two electrodes of the at least one pair of electrodes 1a, 1b;
a mapping module configured to place said locations on a map; and
a signaling module configured to alert a user when approaching said locations.

The present invention also relates to computer readable storage mediums which comprise instructions to encompass one or more processors to perform the any of the steps associated with the method according to the present invention. Said storage mediums may comprise non-transitory means such as hard disks, RAM, ROM, EPROM, EEPROM, solid state drives (SSD), flash drives, CDs, DVDs, etc.

Lastly, the present invention also relates to an electric weeding applicator, which can be a vehicle, handheld or hand-pushed device, capable of preventing or mitigating electric arcs comprising:
at least one pair of electrodes 1a, 1b near or in contact with the soil;
at least one power supply electrically coupled to the at least one pair of electrodes 1a, 1b;
   the system comprising:
a monitoring module coupled to the at least one pair of electrodes 1a, 1b and configured to sense at least one electrical parameter 7; and
a control module coupled to the at least one power supply and the monitoring module, wherein the control module is configured to:
   switch OFF 15 power supply to the at least one pair of electrodes 1a, 1b if the sensed electrical parameter has a value 13 indicative that a region of higher conductivity 3 has connected at least two electrodes of the at least one pair of electrodes 1a, 1b; and
   after a determined time interval 18, switch ON 14 the power supply.

### Insulation Mats

In a preferred embodiment, insulation mats may be placed directly behind and/or in front of the electrodes. This reduces electrical interaction between trailing electrodes and allows for shorter applicator lengths (electrode-to-electrode distance). It also protects the bracket of the electrodes. The mounting of the mats can be made of plastic (e.g., plastic screws) in order to maintain the insulation level that the mat represents. Since the insulation mat and electrode are preferably wearable items, they may comprise a quick-change device to reduce assembling effort.

In order to be able to change the electrodes more reliably, in one embodiment of a quick-change device the electrodes are mounted on a metal object (e.g., by means of screws). The electrical connection to the cable which delivers the electrical energy to the electrode is fixed to the metal object. When changing the electrodes, the electrical connection to the cable does not need to be interrupted, which reduces misuse.

### Sectorized Electrodes

As shown in [symbol] , the present invention contains a pair of electrodes 1a, 1b each with their own charge, plus and minus, so as to generate a difference in electrical potential. In a preferred embodiment, shown in [symbol] , at least one electrode of the pair of electrodes 1a, 1b is a sectorized electrode.

In the context of the present invention, a sectorized electrode is an electrode which comprises a plurality of discreet and spaced apart electrodes instead of a single continuous electrode. This means each physically separated electrode forms a separated sector, or sectorized electrode, with its own electrical potential.

[symbol] shows an electrode arrangement in which a first electrode 1a (e.g., positively charged) is sectorized and alternately arranged in the direction of travel 4 in front of and behind a continuous electrode 1b (e.g., negatively charged). Each sectorized electrode may be connected to an individually controlled power source (not shown). The distance of the sectorized electrodes from each other provides a higher degree of electrical independence and thus a more uniform treatment result.

Therefore, the system according to the present invention may further include an embodiment wherein at least one electrode of the pair of electrodes 1a, 1b is a sectorized electrode.

### Spraying Liquids

It is advantageous if the electrical treatment of the plants is combined with the spraying of liquid onto the substrate and/or the plants. To ensure electrical decoupling of the liquid from possibly live parts, it is advantageous if the spraying system, typically consisting of a water tank, spray heads, spray head mountings, a pump, and a power supply, is electrically isolated from the rest of the system, e.g. the chassis of the vehicle.

In one embodiment, a cable and a residual current device may be installed between the spray system and the rest of the system to detect a residual current in case of an insulation fault.

1. A method for preventing or mitigating electric arcs in electrical weeding applicators including at least one pair of electrodes near or in contact with the soil and at least one power supply electrically coupled to the at least one pair of electrodes, the method comprising the steps of:
sensing at least one electrical parameter between the at least one pair of electrodes;
switching OFF the power supply to the at least one pair of electrodes if the sensed electrical parameter has a value indicative that a region of higher conductivity has connected at least two electrodes of the at least one pair of electrodes;
after a determined time interval, switching ON the power supply.

2. The method according to claim 1 wherein the at least one electrical parameter is selected from the group comprising a voltage, a current, an impedance and an electrical power.

3. The method according to claim 1 further comprising:
before the determined time interval has elapsed, momentarily switching ON the power supply and sensing the at least one electrical parameter; and
keeping the power supply switched ON if the at least one sensed electrical parameter has a value indicative that the at least one pair of electrodes is not connected by a region of higher electrical conductivity.

4. The method according to claim 1 further comprising:
determining and storing locations where the sensed electrical parameter indicated that a region of higher electrical conductivity connected at least two electrodes of the at least one pair of electrodes;
placing said locations on a map; and
alerting a user when approaching said locations.

5. An electrical weeding system for preventing or mitigating electric arcs in electrical weeding applicators including at least one pair of electrodes near or in contact with the soil and at least one power supply electrically coupled to the at least one pair of electrodes, the system comprising:
a monitoring module coupled to the at least one pair of electrodes and configured to sense at least one electrical parameter; and
a control module coupled to the at least one power supply and the monitoring module, wherein the control module is configured to:
switch OFF power supply to the at least one pair of electrodes if the sensed electrical parameter has a value indicative that a region of higher conductivity has connected at least two electrodes of the at least one pair of electrodes; and
after a determined time interval, switch ON the power supply.

6. The system according to claim 5 wherein the at least one electrical parameter is selected from the group comprising a voltage, a current, an impedance and an electrical power.

7. The system according to claim 5 wherein the control module is further configured to comprise:
before the determined time interval has elapsed, momentarily switch ON the power supply and checking the sensed at least one electrical parameter; and
keep the power supply switched ON if the at least one sensed electrical parameter has a value indicative that the at least one pair of electrodes is not connected by a region of higher electrical conductivity.

8. The system according to claim 5 further comprising:
a positioning module configured to determine and store locations where the sensed electrical parameter indicated that a region of higher electrical conductivity connected at least two electrodes of the at least one pair of electrodes;
a mapping module configured to place said locations on a map; and
a signaling module configured to alert a user when approaching said locations.

9. The system according to claim 5 wherein at least one electrode of the pair of electrodes is a sectorized electrode.

10. A computer readable storage medium comprising stored therein in instructions which, when executed by one or more processors, cause the processor to perform the method as defined in claim 1.

11. An electrical weeding applicator capable of preventing or mitigating electric arcs comprising:
at least one pair of electrodes near or in contact with the soil;
at least one power supply electrically coupled to the at least one pair of electrodes;
a monitoring module coupled to the at least one pair of electrodes and configured to sense at least one electrical parameter; and
a control module coupled to the at least one power supply and the monitoring module, wherein the control module is configured to:
switch OFF power supply to the at least one pair of electrodes if the sensed electrical parameter has a value indicative that a region of higher conductivity has connected at least two electrodes of the at least one pair of electrodes; and
after a determined time interval, switch ON the power supply.

12. The applicator according to claim 11 further comprising at least one insulating mat arranged in front and/or behind the at least one pair of electrodes.

13. The applicator according to claim 11 further comprising a spraying system for spraying liquids onto the plants being treated, wherein the spraying system preferably comprises a cable and a residual current device installed between the spraying system and the rest of the applicator to detect a residual current in case of an insulation fault.

14. The applicator according to claim 11 wherein the applicator comprises one of a vehicle, a handheld device or a hand-pushed device.

15. The applicator according to claim 11 wherein the control module is further configured to comprise:
before the determined time interval has elapsed, momentarily switch ON the power supply and checking the sensed at least one electrical parameter; and
keep the power supply switched ON if the at least one sensed electrical parameter has a value indicative that the at least one pair of electrodes is not connected by a region of higher electrical conductivity.
